(19) United States
(12) Patent Application Publication
(10) Pub. No.: US 2026/0343132 A1
(43) Pub. Date: Oct. 29, 2026

(54) CHARGING INTERFACE FOR AN ELECTRICAL DEVICE

(71) Applicant: Sivantos Pte. Ltd., Singapore (SG)

(72) Inventor: Thilo VON MANSBERG, Erlangen (DE)

(21) Appl. No.: 19/662,007

(22) Filed: Apr. 29, 2026

(30) Foreign Application Priority Data
Apr. 29, 2025 (DE) 10 2025 116 425.8

(51) Int. Cl. H04R 1/1025; H02J 7/70; H04R 25/00

(52) U.S. Cl. CPC H04R 1/1025; H02J 7/70; H04R 25/556; H04R 2225/021; H04R 2225/31

(57) ABSTRACT

A charging interface for an electrical device, in particular for a hearing device, has a central first feedthrough opening and at least one radially offset second feedthrough opening. A contact piece is disposed in the first feedthrough opening for contacting a first mating contact of a mating charging interface. A contact element with at least one contact extension is disposed in the second feedthrough opening for contacting a second mating contact of the mating charging interface. A permanent magnetic element is axially aligned with the central contact piece. The contact element is made of a magnetizable material and is magnetized by the magnetic element such that the contact extension acts as a magnetic pole for magnetically attracting the mating charging interface. There is also disclosed a charging system and an electrical device.

### CROSS-REFERENCE TO RELATED APPLICATION

This application claims the priority, under 35 U.S.C. § 119, of German Patent Application DE 10 2025 116 425.8, filed Apr. 29, 2025; the prior application is herewith incorporated by reference in its entirety.

### FIELD AND BACKGROUND OF THE INVENTION

The invention relates to a charging interface for an electrical device, particularly for a hearing device. The invention further relates to an electrical device, and to a charging system comprising the electrical device and a charger.

Personal sound amplification products are portable hearing devices that are used in particular to provide hearing assistance to people with hearing loss or impairment. In order to meet the large variety of individual needs, different types of hearing aids are available, such as behind-the-ear (BTE) hearing aids, receiver-in-the-canal (RIC) hearing aids, and in-the-ear (ITE) hearing aids, for example, as well as concha or canal hearing aids (CIC: Completely-In-Channel, IIC: Invisible-In-Channel).

These hearing aids listed as examples are worn on the outer ear or in the ear canal of a hearing aid user. In addition, bone conduction hearing aids and implantable or vibrotactile hearing aids are also available on the market. The stimulation of the damaged ear is performed either mechanically or electrically. Such hearing aids essentially have an input transducer, an amplifier, and an output transducer as their essential (hearing aid) components. The input transducer is usually an acoustoelectric transducer, such as a microphone, for example. The output transducer is usually implemented as an electroacoustic transducer, for example as a miniature loudspeaker (receiver), or as an electromechanical transducer, such as a bone conduction receiver. The amplifier is usually integrated into a signal processing unit.

Hearing devices are generally powered by batteries. The operating time is limited depending on the energy content of the batteries and the requirements of the hearing aid. Given the general trend toward miniaturization, smaller batteries are preferred, which further limits their energy content. To avoid having to frequently replace used batteries, hearing aids can be powered by rechargeable batteries (accumulators) such as nickel-metal hydride (NiMH) or lithium-ion (Li-ion) batteries.

Hearing devices that are powered by rechargeable batteries often have charging interfaces (charging connectors) for establishing an electrical contact with a galvanic charger, thus enabling the rechargeable batteries to remain inside the hearing aid while being recharged. Proprietary charging interfaces are often used in this process. However, it is now known from the mobile phone sector that a large number of providers rely on standard systems. Some devices with rechargeable batteries also use so-called jack plugs. These systems often have the disadvantage that the insertion paths required to establish contact are usually comparatively long, making it difficult to find and connect the corresponding terminals “blindly,” particularly in chargers with charging cradles. Therefore, relatively flat spring contacts (pogo pins) are often used in this area. The latter is known, for example, from the field of cordless landline telephones.

To ensure a secure galvanic connection between the hearing aid and the charger during a charging process in which the battery is charged by means of a charging current from a charger, it is possible to secure the electrical contact with a holding force, for example.

Publications US 2021/0029475 A1 and US 2024/0205619 A1 and their European counterparts EP 3 771 225 A1 and EP 4 387 272 A1, for example, disclose chargers for a hearing device in which the charger-side charging contact connection has a permanent magnet in order to provide a magnetic holding force in the contacted state.

For example, the charging interface on the hearing device side has a magnetizable metal surface which can be suitably magnetized by the permanent magnet on the charger side. This ensures that the hearing device is held in place on the charger during the charging process by means of a magnetic holding force that develops between the permanent magnet on the charger side and the metal surface on the hearing device side.

The metal surface on the hearing device side is therefore magnetized, at least temporarily, by the magnetic field of the permanent magnet. In other words, an induced magnetization is created which causes a passive attraction between the charging interfaces. The resulting magnetization of the metal surface is usually comparatively weak and less stable, and the holding force is generally oriented in such a way that the metal surface is attracted in the direction of the permanent magnet via the shortest path. As a result, the holding force does create a magnetic attraction between the charging interfaces, but this does not usually result in the contact and mating contact elements being correctly positioned relative to one another for the galvanic connection.

For example, it is conceivable for mechanical guide contours to be provided which align the charging interfaces relative to one another in the event of magnetic attraction and bring them into the desired contact position or contact orientation for carrying out the charging process. For example, the charging interface on the hearing device side can be designed with a funnel-shaped or dome-shaped recess, for example in the form of a spherical trough, as a guide contour, so that when the charging interface on the charger side engages in the recess, the charging contacts are mechanically centered relative to one another.

Additionally or alternatively, it is conceivable, for example, to also provide a permanent magnet (counter-magnet) at the charging interface on the hearing device side. The two permanent magnets of the charging interfaces interact as independent magnetic field sources with defined poles, the permanent magnets being aligned in the hearing device and the charger in such a way that, in the contacted or charging state, the north pole of one permanent magnet faces toward the south pole of the other permanent magnet. As they approach, the charging interfaces align themselves due to the fixed magnetization, thus bringing the north and south poles adjacent to one another (attraction). This self-alignment is very stable, because both magnets represent their own constant magnetic field source. This makes it possible to automatically bring the contact points of the charging interfaces into a desired relative position to one another through magnetic self-alignment, thus reducing or completely eliminating the need for additional mechanical guide contours.

Typically, the permanent magnet on the hearing device side is located inside the hearing device housing and behind a charging contact of the charging interface. Oftentimes, a printed circuit board connected to the charging contact is also positioned between the charging contact and the permanent magnet. The charging contact and the permanent magnet are therefore located on different sides of the printed circuit board. The resulting spatial distance must be bridged by the magnetic flux of the permanent magnet. This is not ideal, as it adversely reduces the magnetic attraction, holding force, or self-alignment. Therefore, permanent magnets of commensurate strength are needed, which makes such permanent magnetic charging interfaces costly and space-consuming.

### SUMMARY OF THE INVENTION

It is the object of the invention to provide an especially suitable charging interface for an electrical device. In particular, the magnetic holding force for securing a galvanic charging connection is to be improved. Preferably, magnetic self-alignment of the charging interface to a mating charging interface is to also be enabled. It is also an object of the invention to provide a suitable electrical device as well as a suitable charging system.

With the above and other objects in view there is provided, in accordance with the invention, a charging interface for an electrical device, the charging interface comprising:
a housing portion formed with a central first feedthrough opening and with at least one radially offset second feedthrough opening;
a central contact piece for contacting a first mating contact of a mating charging interface, wherein the first mating contact is disposed in said first feedthrough opening;
a contact element having at least one contact extension for contacting a second mating contact of the mating charging interface, wherein the second mating contact is disposed in said second feedthrough opening;
a permanent magnetic element arranged in axial alignment with said central contact piece;
a printed circuit board disposed between said magnetic element and said central contact piece,
said contact element being made of a magnetizable material and being magnetized by said magnetic element and said contact extension acting as a magnetic pole for magnetically attracting the mating charging interface.

The advantages and embodiments mentioned with regard to the charging interface can also be applied analogously to the electrical device and/or the charging system and vice versa.

The conjunction “and/or” is to be understood here and in the following such that the features linked by this conjunction can be formed both jointly and as alternatives to one another.

The charging interface according to the invention is intended for an electrical device and is suitable and designed for the same. The electrical device is in particular a hearing device, preferably a personal sound amplification product, such as a behind-the-ear (BTE) hearing aid. The terms hearing device and hearing aid are interchangeably used herein. The invention is suitably configured for hearing devices in general and specifically and preferably for hearing aids, which support hearing deficiencies for the hearing impaired and the hard of hearing.

The charging interface according to the invention is intended and designed to be galvanically contacted with a mating charging interface of a charger in order to carry out a charging process for recharging an internal energy storage device (device battery). The charging interface and mating charging interface thus have complementary electrical contacts or contact points which are in mechanical contact during a charging operation. For example, a mating charging interface is used as described in the above-noted, commonly assigned disclosures US 2021/0029475 A1, US 2024/0205619 A1, EP 3 771 225 A1 and EP 4 387 272 A1. The disclosures of our prior publications, in particular the claims (with accompanying explanations), are hereby incorporated by reference.

The electrical device has a (device) housing with a housing portion. The housing portion here refers in particular to a section of an outer housing wall (outer wall) of the housing. The housing portion has a central first feedthrough opening and at least one radially offset second feedthrough opening. The hole-like feedthrough openings are embodied as passages or breaches in the housing portion which connect the interior of the housing to the environment.

Here and in the following, “axial” or “axial direction” is understood to mean in particular a direction parallel to (coaxial with) a center axis of the first feedthrough opening, i.e., perpendicular to the opening surfaces of the first feedthrough opening. Accordingly, here and in the following, “radial” or a “radial direction” is understood to mean in particular a direction oriented perpendicular (transverse) to the center axis of the first feedthrough opening along a radius of the first feedthrough opening. Here and in the following, “tangential” or a “tangential direction” is understood to mean in particular a direction along the circumference of the feedthrough opening (circumferential direction, azimuthal direction), i.e., a direction perpendicular to the axial direction and the radial direction.

For galvanically contacting the mating charging interface, and for energy transfer during a charging operation, the charging interface has a contact piece and a contact element as charging contacts (terminal contacts).

The contact piece is designed to contact a first mating contact of the mating charging interface. The contact piece is located in the first feedthrough opening. In other words, the contact piece fits radially into the feedthrough opening in a form-fitting manner.

In the following, a “form-fitting” or “form-fitting connection” between at least two interconnected parts is understood in particular to mean that the cohesion of the interconnected parts is achieved at least in one direction through direct interlocking of contours of the parts themselves or through indirect interlocking via an additional connecting part. Therefore, mutual movement in this direction is blocked by the form. The form-fitting connection may also be referred to as a positive (lock) connection.

The contact element has at least one contact extension which is designed to contact a second mating contact of the mating charging interface. According to the invention, the contact element is additionally provided and designed to enable magnetic attraction with the mating charging interface. The contact extension is located in the second feedthrough opening. In other words, the contact extension engages at least partially with or passes through the second feedthrough opening. The contact element, in particular the contact extension, is made of a magnetizable material. This means that the contact element or contact extension has a certain magnetic permeability and is made of a ferromagnetic, ferrimagnetic, or paramagnetic material.

The charging interface also features a permanent magnetic element which is arranged so as to be axially aligned with the central contact piece. The magnetic element is therefore embodied as a permanent magnet.

According to the invention, the contact element is magnetized by the magnetic element in such a way that the contact extension acts as a magnetic pole for the purpose of magnetically attracting the mating charging interface. The magnetic element thus causes a substantially permanently induced magnetization of the contact element, in particular of the contact extension, so that the magnetic flux of the magnetic element is guided or focused through the contact or bearing surface of the contact extension for the second mating contact. Thus, the contact surface for the second mating contact acts as an independent and stable magnetic field source. This creates an especially suitable charging interface for an electrical device. In particular, a magnetic field source is thus realized directly at the galvanic contact point of the charging interface, thereby enabling reliable magnetic holding forces for a charging operation.

Through the magnetization of the contact extension, a magnetic pole is thus produced on the device side which is arranged on the housing portion and positioned at an especially short distance to the second mating contact. This is particularly advantageous for applications with mating charging interfaces in which the mating charging interface also has a permanent magnetic element (counter-magnet) for magnetic attraction, since magnetic self-alignment between the contact extension and the second mating contact is thus enabled due to the orientation of the magnetic poles.

Preferably, the contact element has a number of contact extensions, i.e., a plurality of contact extensions, for example three contact extensions, each of which is seated in an associated second feedthrough opening and which are arranged so as to be tangentially distributed around the first feedthrough opening. The magnetic self-alignment of the contact extensions with the at least one second mating contact also enables a magnetic self-alignment of the contact piece with the first mating contact. This makes it possible for the charging interface to automatically align itself relatively when approaching the mating charging interface and to make reliable contact therewith. It is thus possible to omit mechanical guide contours, such as a funnel- or dome-shaped recess, on the housing portion, so that the housing portion in the area of the contact points can be manufactured without a housing curvature/bulge. In other words, the housing portion is flat or machinable, thus allowing for additional freedom in the housing design.

In an advantageous refinement, the contact piece and the contact extension protrude at least partially axially upward from the housing portion. In particular, the contact piece and the contact extension each have an axial projection toward the outside of the housing relative to the housing portion. The contact points of the charging interface with the mating charging interface, i.e., the contact piece and the at least one contact extension, are thus accessible from the outside of the housing and can be easily cleaned if necessary, i.e., freed from dirt (e.g., cerumen).

In one expedient embodiment, the axial projection of the contact piece is dimensioned substantially the same as the axial projection of the contact extension. In other words, the contact points protrude from the housing portion in the same way. In particular, the contact surfaces of the contact piece and the contact extension are arranged in a common plane. This makes cleaning the contact points especially easy, particularly in the case of a housing portion without an additional mechanical guide contour.

In an advantageous embodiment, the magnetic element has a mechanical contact with the contact element. The magnetic element is therefore in contact with the contact element, at least in portions. There is therefore a direct or immediate contact between the magnetic element and the contact element. Thus, there is essentially no clearance or gap between the magnetic element and the contact element that needs to be bridged by the magnetic field. This improves the magnetization of the contact element by the magnetic element, so that higher magnetic holding forces can be subsequently achieved with the contact extension. This makes it possible to use a magnetic element with a lower magnetic field strength, for example, which can advantageously reduce manufacturing costs and adverse interactions with current-carrying components.

In a preferred embodiment, the contact element is embodied as a ring yoke surrounding the magnetic element, i.e., as a cuff which encloses or encompasses the magnetic element, or as a hollow cylinder (tube). The magnetic element is therefore inserted at least partially radially and form-fittingly into a central (ring) opening of the ring yoke and is delimited on the outer circumference or tangentially by the ring yoke. The ring yoke is embodied in particular as a circular cylinder, the magnetic element being circular in particular and fitting with the ring yoke opening as precisely as possible. The magnetic element is held or fixed in position, for example, due to the magnetic attractive forces caused by the induced magnetization of the surrounding ring yoke. Additionally or alternatively, the magnetic element can be held in place by means of mechanical structures and/or by a material-locking adhesive connection.

The at least one contact extension is formed so as to project axially upward on the ring yoke on an end face facing toward the housing portion. The contact extension is integrally formed, i.e., in a single piece or monolithically, and molded onto the face of the ring yoke. The contact extension is embodied in particular as a ring segment of the ring yoke that stands upright on the front face.

The arrangement of the magnetic element inside the ring yoke ensures reliable and uniform magnetization of the contact element or of each contact extension. In particular, a large and preferably flush contact surface for the magnetic element is realized along the inner ring wall of the central opening.

In an advantageous refinement, the charging interface has an internal printed circuit board (PCB) which is positioned between the magnetic element and the contact piece. The contact element is thus located on an underside of the printed circuit board facing toward the housing portion, and the magnetic element and preferably the contact element are arranged on an oppositely situated top side.

The stacked arrangement allows for an especially compact design of the charging interface inside the housing. The reduced space requirement in the device housing allows for additional freedom regarding the form factor and design of the device housing.

The printed circuit board is, for example, surrounded by the contact extension on its edge or circumference. The contact extension is therefore guided past the printed circuit board in order to engage in the second feedthrough opening of the housing portion. Alternatively, it is conceivable, for example, for the printed circuit board to have a third feedthrough opening for the contact extension which is arranged so as to be axially aligned with the second feedthrough opening.

The printed circuit board is electrically contacted with the contact piece and the contact element, connecting them to the device battery. The contact piece and the contact element, in particular the ring yoke, are preferably located directly on the printed circuit board and soldered thereto, for example. Preferably, the contact piece and/or the contact element are surface-mounted devices (SMD) which are mounted on or contacted with the printed circuit board. This further reduces the space required for the charging interface.

In an axially stacked SMD design of the charging interface, the axial projection of the charging contacts (contact piece, contact extension) relative to the housing portion can be dimensioned relatively precisely, since simple tolerance control is possible which essentially only varies with regard to the dimensions of the contact element or of the contact extension and housing portion.

In a preferred embodiment, the housing portion has a one-piece molded holding device for supporting the contact element axially and radially. The mounting of the contact element also indirectly holds the magnetic element, the printed circuit board, and the contact piece radially and axially relative to the housing portion. This ensures a defined installation position for the charging interface within the device housing.

In one conceivable embodiment, the holding device has at least one locking hook for axial locking or clipping onto an edge of the contact element. The locking hook is integrally molded onto an inner surface of the housing portion and stands axially upward. This simplifies installation on the housing portion, as no separate holding or mounting elements (e.g., screws) are required.

The locking hook has a locking tab which extends axially in the relaxed state and which is provided at its free end with a wedge-shaped locking nose, for example. The locking hook or locking tab is designed to be radially flexible, meaning that the locking tab is designed to be elastically flexible in the radial direction against a restoring force.

This allows for especially simple axial plug-in mounting of the charging interface in the housing. For this purpose, the magnetic element, the contact element, the printed circuit board, and the contact piece are moved axially as a (pre-assembled) assembly in the direction of the housing portion, causing the locking hook to come into contact with the free end of the contact extension. The locking nose slides along an edge or border of the contact extension and is thus moved or deflected radially. This mechanically tensions the locking tab, causing the locking nose to move radially inward due to the resulting restoring force once the locking nose has moved completely past the edge or perimeter of the contact element. As a result, the locking nose engages behind the edge or border of the contact element, so that the locking hook axially locks or clips onto the edge of the contact element as a mating contour in a form-fitting and/or force-fitting manner.

In the following, a “force-fit” or “force-fitting connection” between at least two interconnected parts is understood in particular to mean that the interconnected parts are prevented from sliding against each other due to a frictional force acting between them. If a “connecting force” that causes this frictional force is missing (this means the force that pushes the parts against each other, for example a screw force or the force of gravity itself), the frictional connection cannot be maintained and can therefore be broken.

A radial form-fit of the holding device for the contact element is achieved in particular by a number of tangentially distributed locking hooks. Preferably, the holding device has a number of locking hooks corresponding to the number of contact extensions.

In one expedient embodiment, the locking hook is formed on an edge of the second feedthrough opening, so that the locking hook borders tangentially on the outside edge of the second feedthrough opening. In other words, the locking hook, in particular the locking tab, is axially aligned with the edge of the second feedthrough opening. The locking nose overlaps with the feedthrough opening in a radial direction. This means there is no undercut on the housing portion between the locking hook and the second feedthrough opening. This makes demolding the housing portion especially easy during injection molding. In particular, this makes it possible to use a structurally very simple injection molding tool.

In an advantageous refinement, the charging interface has a sealing element for sealing the first feedthrough opening and the second feedthrough opening(s) on the inside of the housing. The sealing element is positioned particularly between the inner surface of the housing portion and the printed circuit board. This prevents, in particular, the entry of contaminants (e.g., cerumen) into the housing. Additionally or alternatively, the sealing element is intended and designed to prevent the passage of liquid and/or gaseous substances into the housing.

The sealing element, for example, is axially elastically compressible and is at least partially axially compressed in the assembly position. This causes the sealing element to exert an axial restoring force in the mounting position, which pushes the assembly (printed circuit board, contact piece, magnetic element, contact element) away from the inside of the housing portion, so that the axial form-fit of the contact element with the locking hook of the holding device is ensured by means of a tensile stress. The compressible sealing element thus achieves an axially force-fitting fixation of the form-fitting rear grip of the contact element. This makes an especially stable mounting position of the charging interface possible, further simplifying assembly.

The electrical device according to the invention is embodied in particular as a hearing device, preferably as a personal sound amplification product, or a hearing aid for the hearing-impaired. The electrical device has a housing with a housing portion. A charging interface as described above is located on the housing portion. This results in an especially suitable electrical device. In particular, an electrical device is thus realized in which an increased magnetic holding force for ensuring the galvanic charging connection during a charging operation is made possible.

The charging system according to the invention comprises an electrical device as described above and a charger for charging a device battery of the electrical device. The charger has a mating charging interface for electrical, galvanic contact with the charging interface. The mating charging interface has a first mating contact for electrically contacting the contact piece and a second mating contact for contacting the contact extension of the contact element. The charger also features a permanent magnetic element that creates a magnetic field in the direction of the second mating contact.

The magnetized contact extension and the magnetic field oriented toward the second mating contact effectively create a magnetic interaction between two magnetic poles, which enables both improved magnetic holding force and magnetic self-alignment between the galvanic interfaces. This results in an especially suitable charging system.

Other features which are considered as characteristic for the invention are set forth in the appended claims.

Although the invention is illustrated and described herein as embodied in a charging interface for an electrical device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic representation of a charging system with an electrical device in the form of a hearing device and with a charger;

FIG. 2 is a perspective view of the electrical device looking toward a charging interface;

FIG. 3 is a perspective view of the charging interface looking at an outer side;

FIG. 4 is a perspective view of the charging interface looking at an inner side;

FIG. 5 is a perspective view of the charging interface in a disassembled state or an exploded view;

FIG. 6 is a sectional view of the charging interface taken along the sectional line VI-VI in FIG. 3; and

FIG. 7 is a sectional view of the charging interface taken along the sectional line VI-VI in FIG. 3 with a magnetic field profile.

Corresponding parts and sizes are provided with the same reference symbols throughout the figures.

### DETAILED DESCRIPTION OF THE INVENTION

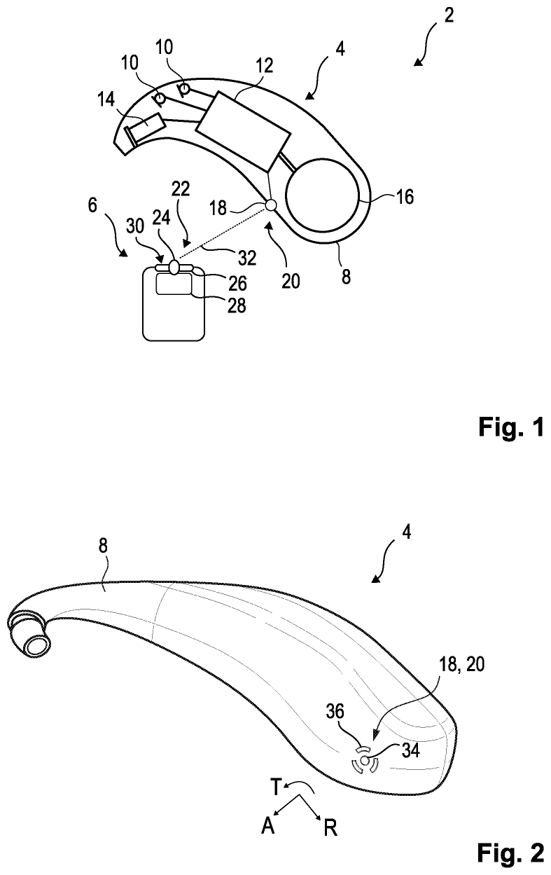

Referring now to the figures of the drawing in detail and first, in particular, to FIG. 1 thereof, there is shown a schematic and simplified representation of a charging system 2 with an electrical device 4 and with a charger 6.

In the exemplary embodiment that is depicted, the electrical device 4 is embodied as a hearing device, in particular as a behind-the-ear (BTE) hearing device. Alternatively, the device 4 can also be embodied, for example, as an in-the-ear hearing device (ITE), in particular as an instant fit or with an individual (housing) shell.

The device 4 comprises, as is shown schematically in FIG. 1, a (hearing aid) housing (housing shell) 8 in which a plurality of microphones, also referred to as (acoustoelectric) input transducers 10, are installed. In this exemplary embodiment, for example, the device 4 has two input transducers 10.

The input transducers 10 capture (airborne) sound or acoustic signals in the vicinity of the device 4 and convert them into electrical input signals, in particular into multi-channel input signals. A signal processing unit 12, which is also integrated into the device housing 8, processes the input signals and generates an output signal for an output transducer 14, in particular an electroacoustic transducer, which is embodied, for example, as a loudspeaker or earphone, and which outputs an acoustic signal. In the device 4, the acoustic signal is transmitted, if necessary, via a sound tube (not shown in detail here) or an external receiver, which has an earmold inserted in the ear canal, to the eardrum of a hearing system user. However, an electromechanical output transducer could also be used as the receiver, as in a bone conduction receiver, for example.

The power supply of the device 4 and, in particular, that of the signal processing unit 12 is provided by a rechargeable device battery 16 that is integrated into the device housing 8. To charge the device battery 16 with electrical energy, the device 4 also has a charging interface 18 as a charging port. The charging interface 18 is positioned on a housing portion 20 of the device housing 8. For example, charging electronics associated with the charging interface 18 for carrying out a charging process are integrated into the signal processing unit 12.

The charger 6 has a mating charging interface 22 for galvanically contacting the charging interface 18. The mating charging interface 22 has a first mating contact 24, a second mating contact 26, and a permanent magnetic element 28 which creates a magnetic field in the direction of the mating contact 26.

The mating contacts 24, 26 are arranged concentrically to one another. The centrally positioned mating contact 24 is embodied, for example, as a contact pin, in particular as a spring contact pin or pogo pin, the particularly ring-shaped mating contact 26 surrounding the mating contact 24 on its circumference. The mating contact 26 has a ring-shaped contact surface 30 on its end face.

The galvanic contact between the charging interface 18 and the mating charging interface 22 during a charging operation of the device battery 16, in which electrical energy is fed from the charger 6 into the device 4 or into the device battery 16, is shown schematically in FIG. 1 with a line 32.

FIG. 2 shows the electrical device 4 in a perspective view looking at the housing portion 20 and the charging interface 18 located there.

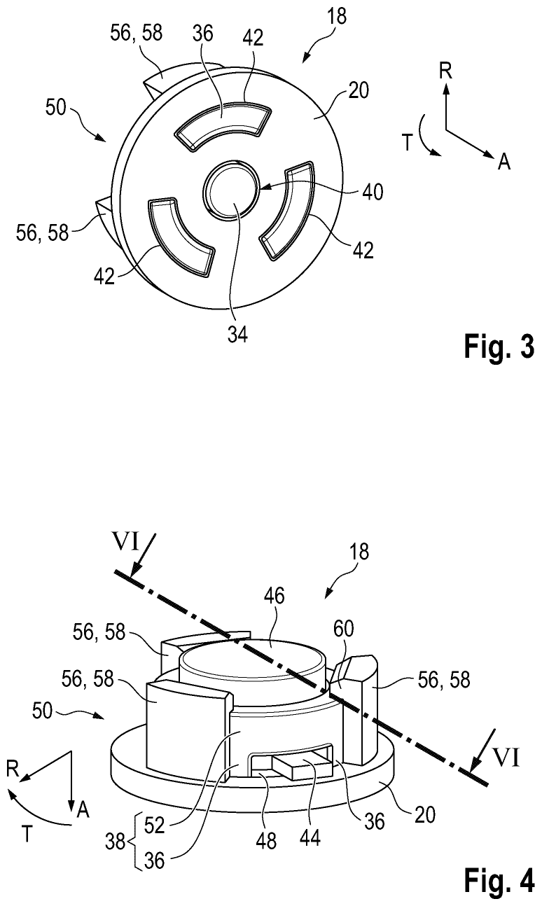

As can be seen particularly in FIG. 3, the charging interface 18 has four raised contact surfaces for the mating contacts 24, 26 on an outer side of the housing portion 20. A central circular contact surface is surrounded by three sector-like contact surfaces. The sector-like contact surfaces are arranged at a 120° angle to one another around the circular contact surface. Each sector-like contact surface corresponds substantially to a circular segment of a larger imaginary circle.

The central, circular contact surface of the charging interface 18 is formed by a circular cylindrical contact piece 34, with the sector-like contact surfaces being formed by three contact extensions 36 of a contact element 38 (FIG. 4). The figures show, by way of example, only one contact extension 36 with a reference symbol.

The contact piece 34 and the contact extensions 36 each pass through a feedthrough opening 40, 42, which are provided in the housing portion 20. The contact piece 34 is located in the central feedthrough opening 40, with the contact extensions 36 each being located in a feedthrough opening 42.

The following information regarding spatial directions is given particularly in a coordinate system of the charging interface 18. Here and in the following, “axial” or “axial direction A” is understood to mean in particular a direction parallel to (coaxial with) a center axis of the feedthrough opening 40, i.e., perpendicular to the opening surfaces of the feedthrough opening 40. Accordingly, here and in the following, “radial” or a “radial direction R” is understood to mean in particular a direction oriented perpendicular (transverse) to the center axis of the feedthrough opening 40 along a radius of the feedthrough opening 40. Here and in the following, “tangential” or a “tangential direction T” is understood to mean in particular a direction along the circumference of the feedthrough opening 40 (circumferential direction, azimuthal direction), i.e., a direction perpendicular to the axial direction A and the radial direction R.

The structure of the charging interface 18 is explained in greater detail below with reference to FIGS. 4 to 7.

In addition to the contact piece 34 and the contact element 38, the charging interface 18 has a printed circuit board 44, a permanent magnetic element 46, a sealing element 48, and a holding device 50.

In the illustrated embodiment, the magnetic element 46 is embodied particularly as a circular cylinder.

The contact element 38 has a hollow cylindrical or cuff-like ring yoke 52 with a central ring opening into which the magnetic element 46 is inserted in the assembled state. The contact extensions 36 are formed so as to project axially upward on an end face of the ring yoke 52 facing toward the housing portion 20. In particular, the contact extensions 36 are integrally formed, i.e., in one piece or monolithically, onto the ring yoke 52. The contact extensions 36 are thus embodied as a ring segment of the ring yoke 52 that stands upright on the front face.

The magnetic element 46 is enclosed in a radially form-fitting manner by the ring yoke 52 in the assembled state. In particular, the magnetic element 46 is located on the inner circumference of the ring opening with a mechanical contact.

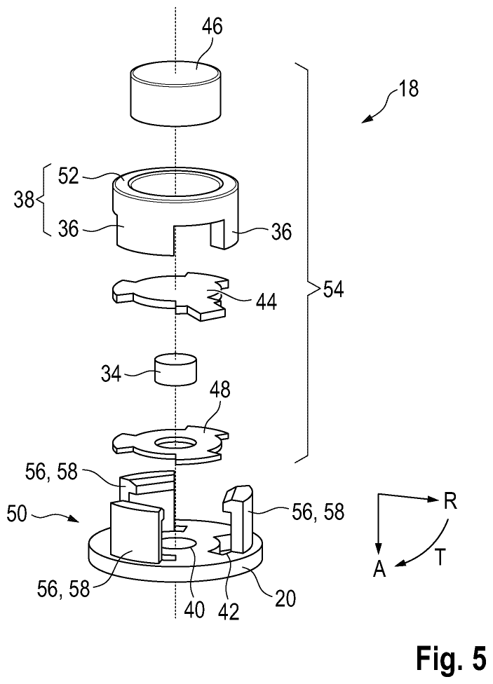

The contact piece 34, the contact element 38, the printed circuit board 44, the magnetic element 46, and the sealing element 48 are arranged in the assembled state as an assembly 54, at least partially stacked axially on top of each other. As can be seen relatively clearly in the illustration of FIG. 5, the magnetic element 46 is positioned so as to be axially aligned with the contact piece 34. In particular, the center axes of the magnetic element 46 and the contact piece 34 are aligned coaxially with one another.

In the assembly 54, the printed circuit board 44 is positioned between the contact element 38 and the contact piece 34. Here, the contact piece 34 is arranged on a lower side of the printed circuit board 44 facing toward the housing portion 20, and the magnetic element 46 and the contact element 38 are arranged on an oppositely situated upper side. The contact piece 34 and the contact element 38 are surface-mounted devices (SMDs) which are mounted on the printed circuit board 44. The printed circuit board 44 is thus electrically contacted with the contact piece 34 and the contact element 38 and connects them to the charging electronics. For example, the printed circuit board 44 at least partially forms part of the signal processing unit 12.

The printed circuit board 44, for example, is surrounded on its edge or circumference by the three contact extensions 36. In other words, the axially extending contact extensions 36 are guided past the printed circuit board 44 so that they engage at their free ends in the feedthrough openings 42 of the housing portion 20. In this embodiment, the printed circuit board 44 has, for example, unspecified edge recesses, approximately groove-like, in which the contact extensions 36 are guided. In an alternative embodiment (not shown), the printed circuit board 44 has three feedthrough openings which are arranged so as to be axially aligned with the feedthrough openings 42 and which are penetrated by the contact extensions 36.

The disc-shaped sealing element 48 is positioned between the printed circuit board 44 and the housing portion 20 in the assembled state. The sealing element 48 is intended for, and suitable and designed for, sealing the feedthrough openings 40, 42 on the inside of the housing. The sealing element 48 has a central, hole-formed recess for the contact piece 34. Furthermore, the sealing element 48 has, for example, groove-shaped recesses for the contact extensions 36.

The holding device 50 is integrally formed on the housing portion 20 and is intended and designed to fix the assembly 54 to the housing portion 20 in an installation position.

The holding device 50 has three axially upwardly protruding locking hooks 56 which are molded onto the inside of the housing portion 20 and axially lock or clip into the assembly 54, particularly into the contact element 38. The mounting of the contact element 38 also indirectly fixes the rest of the assembly 54, i.e., the magnetic element 46, the printed circuit board 44, the contact piece 34, and the sealing element 48, relative to the housing portion 20.

The locking hooks 56 each have an axially extending and radially flexible locking tab 58. The locking tabs 58 each have a radially inwardly oriented locking nose 60 on their free end. The locking tabs 58 are each formed on one edge of one of the feedthrough openings 42. In particular, the locking tabs 58 are each axially aligned with the edge of the respective associated feedthrough opening 42. The wedge-shaped locking noses 60 are formed on the locking tabs 58 in such a way that they overlap radially with the associated feedthrough openings 42.

To assemble the charging interface 18, the assembly 54 is moved axially from inside the housing toward the housing portion 20 so that the locking hooks 56 come into contact with the free ends of the contact extensions 36. The respective locking noses 60 slide along the contact extensions 36, whereby the locking hooks 56 or the locking tabs 58 are moved or deflected radially outward. This mechanically tensions the locking tabs 58. As soon as the locking noses 60 have completely moved past the end face or the end face edge of the contact element 38, the locking hooks 56, and thus the locking noses 60, are moved radially inward due to the resulting restoring force. This causes the locking noses 60 to engage behind the end face of the contact element 38 facing away from the housing portion 20, so that the assembly 54 is axially fixed to the housing portion 20. Due to the tangential distribution dimension of the locking hooks 56, radial fixation of the assembly 54 by the holding device 50 is still achieved in the locked or clipped state.

The sealing element 48 is axially elastically compressible and is at least partially compressed in the axial direction when the assembly 54 is in the locked state. As a result, the sealing element 48 exerts an axial restoring force which pushes the assembly 54 away from the inside of the housing portion 20, so that the axial form-fit of the contact element 38 on the locking hook 56 of the holding device 50 is ensured by means of a tensile stress.

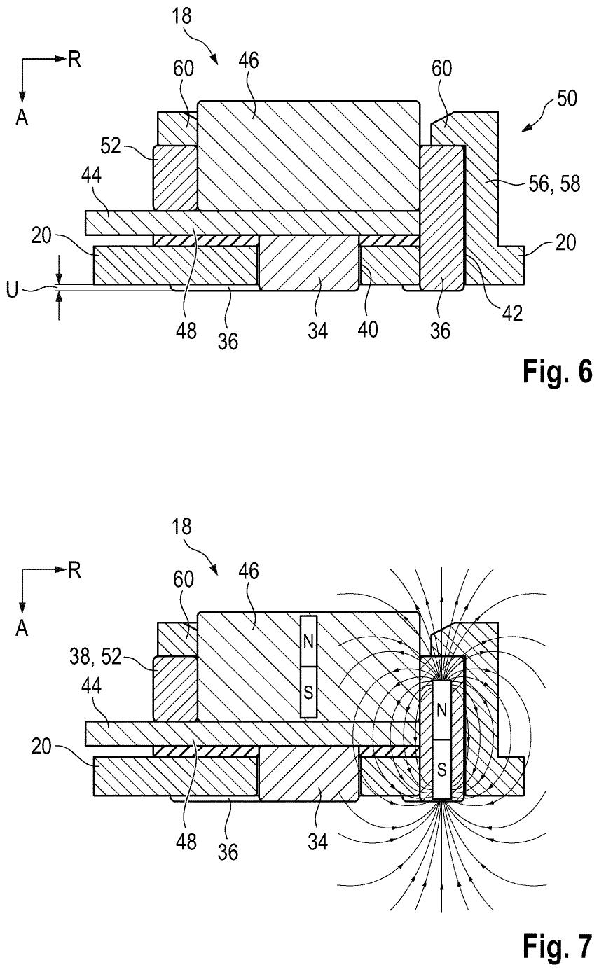

FIG. 6 shows the charging interface 18 in a sectional view along the sectional line VI-VI according to FIG. 3. As can be seen quite clearly in the sectional view, the contact piece 34 and the contact extensions 36 of the housing outer side of the housing portion 20 protrude upward along the axial direction A with an axial projection U. The axial projection U of the contact piece 34 is dimensioned substantially the same as the axial projections U of the contact extensions 36. All contact surfaces of the contact piece 34 and of the contact extensions 36 are thus arranged in a common (contact) plane.

The contact element 38, i.e., the ring yoke 52 and the contact extensions 36, is made of a magnetizable material. The magnetic element 46 thus magnetizes the surrounding ring yoke 52, so that the magnetic element 46 is fixed in the ring yoke 52 due to the resulting magnetic attractive force. As a result, the contact extensions 36 are magnetized in the axial direction A. This is shown schematically in the illustration according to FIG. 7. The magnetization of the magnetic element 46 and depicted contact extension 36 with bar magnets is illustrated schematically. FIG. 7 also shows the profile of the magnetic field lines for the magnetized contact extension 36.

The contact extensions 36 are magnetized by the magnetic element 46 in such a way that the end faces of the contact extensions 36, which protrude axially upward from the housing portion 20, each act as a magnetic pole for the purpose of magnetically attracting the mating charging interface 22. Three magnetic field sources are thus implemented directly at the galvanic contact point of the charging interface 18, enabling reliable magnetic holding forces for a charging process. This makes it possible to design the charging interface 18 or the housing portion 20 without a mechanical guide contour, as can be seen, for example, in the illustrations of FIG. 2 and FIG. 3.

Furthermore, the magnetized contact extensions 36, in conjunction with the magnetic element 28 of the mating charging interface 22 enable magnetic self-alignment between the contact extensions 36 and the magnetic element 28 due to the orientation of the magnetic poles. Since the magnetic element 28 is designed such that its magnetic field is aligned in the direction of the mating contact 26, a self-alignment takes place in which the contact surfaces of the contact extensions 36 are brought into contact with the contact surface 30 of the mating contact 26. By virtue of the centered arrangement of the contact piece 34 and the mating contact 24, these are also contacted with one another during self-alignment.

This results in a charging system 2 with magnetic self-alignment and magnetic fixation of the galvanic contact.

The invention is not limited to the exemplary embodiment described above. Rather, other variants of the invention may also be derived therefrom by a person skilled in the art within the scope of the disclosed claims without departing from the subject matter of the claimed invention. In particular, all the individual features described in connection with the exemplary embodiment can also be combined in other ways within the scope of the disclosed claims without departing from the subject matter of the claimed invention.

The following is a summary list of reference numerals and the corresponding structure used in the above description of the invention:

| | |
|---|---|
| 2 | charging system |
| 4 | device |
| 6 | charger |
| 8 | device housing |
| 10 | input transducer |
| 12 | signal processing unit |
| 14 | output transducer |
| 16 | device battery |
| 18 | charging interface |
| 20 | housing portion |
| 22 | mating charging interface |
| 24 | mating contact |
| 26 | mating contact |
| 28 | magnetic element |
| 30 | contact surface |
| 32 | line |
| 34 | contact piece |
| 36 | contact extension |
| 38 | contact element |
| 40 | feedthrough opening |
| 42 | feedthrough opening |
| 44 | printed circuit board |
| 46 | magnetic element |
| 48 | sealing element |
| 50 | retaining device |
| 52 | ring brace |
| 54 | assembly |
| 56 | locking hook |
| 58 | locking tab |
| 60 | locking nose |
| A | axial direction |
| R | radial direction |
| T | tangential direction |
| U | overhang |

1. A charging interface (18) for an electrical device (4) comprising
a housing portion (20) with a central first feedthrough opening (40) and with at least one radially offset second feedthrough opening (42),
a contact piece (34) for contacting a first mating contact (24) of a mating charging interface (22), which first mating contact (24) is located in the first feedthrough opening (40),
a contact element (38) with at least one contact extension (36) for contacting a second mating contact (26) of the mating charging interface (22), which second mating contact (26) is located in the second feedthrough opening (42),
a permanent magnetic element (46) which is arranged so as to be axially aligned with the central contact piece (34),
a printed circuit board (44), which is arranged between the magnetic element (46) and the contact piece (34),
wherein the contact element (38) is made of a magnetizable material and is magnetized by the magnetic element (46) such that the contact extension (36) acts as a magnetic pole for the purpose of magnetically attracting the mating charging interface (22).

2. The charging interface (18) according to claim 1,
characterized in that
the contact piece (34) and the contact extension (36) protrude at least partially axially upward from the housing portion (20).

3. The charging interface (18) according to claim 1,
characterized in that
the contact element (38) and the magnetic element (46) are in mechanical contact.

4. The charging interface (18) according to claim 1,
characterized in that
the contact element (38) is embodied as a ring yoke (52), which surrounds the magnetic element (46) and on which at least one contact extension (36) is integrally formed in an axially upwardly standing manner on the end face.

5. The charging interface (18) according to claim 4,
characterized in that
at least two contact extensions (36) are integrally formed in an axially upwardly standing manner on the ring yoke (52).

6. The charging interface (18) according to claim 1,
characterized in that
the housing portion (20) has a one-piece molded holding device (50) for supporting the contact element (38) axially and radially.

7. The charging interface (18) according to claim 6,
characterized in that
the holding device (50) has at least one upright locking hook (56) for axial locking on an edge of the contact element (38).

8. The charging interface (18) according to claim 7,
characterized in that
the locking hook (56) is formed on an edge of the second feedthrough opening (42).

9. The charging interface (18) according to claim 7,
characterized in that
a sealing element (48) is provided for sealing the first and second feedthrough openings (40, 42) on the inside of the housing.

10. An electrical device (4) comprising a device housing (8) with a housing portion (20) and a charging interface (18) arranged on the housing portion (20) according to claim 1.

11. An electrical device (4) according to claim 10, wherein the electrical device (4) is hearing device.

12. A charging system (2) comprising an electrical device (4) according to claim 10 and a charger (6) with a mating charging interface (22) for electrically contacting the charging interface (18), wherein the mating charging interface (22) has a first mating contact (24) for contacting the contact piece (34), a second mating contact (26) for contacting the contact extension (36) of the contact element (38), and a permanent magnetic magnet element (28) which generates a magnetic field in the direction of the second mating contact (26).
